(19) United States
(12) Patent Application Publication
(10) Pub. No.: US 2025/0306624 A1
(43) Pub. Date: Oct. 2, 2025

(54) Multicore Processor Clock Distribution Using Asynchronous Wavefront

(71) Applicant: Tenstorrent USA, Inc., Austin, TX (US)

(72) Inventors: Nitin Mohan, Austin, TX (US); Daniel William Bailey, Rollingwood, TX (US)

(21) Appl. No.: 18/911,234

(22) Filed: Oct. 9, 2024

Related U.S. Application Data
(60) Provisional application No. 63/572,257, filed on Mar. 30, 2024.

(51) Int. Cl. G06F 1/10

(52) U.S. Cl. CPC G06F 1/10

(57) ABSTRACT

Systems and methods related to multicore processor clock distribution using an asynchronous wavefront are disclosed herein. A clock signal may be propagated to each node in a predictable and repeatable manner. The clock signal may be provided from a clock source to a subset of nodes of a network of nodes and may be distributed from each node of the subset of nodes to a respective adjacent node. The clock signal may be propagated via the adjacent nodes to any additional nodes of the network that are not among the subset of nodes or the adjacent nodes. Propagating the clock signal in this way may avoid issues related to distributing a zero-skew clock signal directly to all nodes, such as the common point in a clock distribution growing farther in time between two leaf points and higher design margins to account for larger processes, voltage, and temperature variations.

### CROSS REFERENCE TO RELATED APPLICATIONS

This application claims the benefit of U.S. Provisional Patent Application No. 63/572,257, filed Mar. 30, 2024, which is incorporated by reference herein in its entirety for all purposes.

### BACKGROUND

Many computing systems that are directed to accelerating artificial intelligence workloads, such as the execution of an artificial neural network (ANN), use the paradigm of distributed parallel computing embodied by, for example, a multicore processor. More generally, these systems can be referred to as a network of computational nodes. In a multicore processor, collaboration among multiple cores is essential for efficiently executing ANNs. The parallel architecture of multicore processors allows for simultaneous processing of different portions of the ANN, significantly speeding up training and inference tasks. During the execution of an ANN, various layers and operations can be divided among the available cores, enabling concurrent computation and reducing overall processing time. The cores collaborate through efficient communication mechanisms, such as Networks-on-Chips (NoCs). Coordinated data sharing and synchronization mechanisms are implemented to ensure that intermediate results are exchanged seamlessly, enabling the collective execution of complex neural network models. This collaborative approach optimizes the utilization of available computational resources, enhances parallelism, and contributes to the overall acceleration of AI workloads on multicore processors.

However, despite the advantages of parallelism in multicore processors for ANN execution, efficient data sharing among cores presents a significant challenge. Coordinating the flow of data, particularly data associated with large quantities of network data and intermediate results, requires careful consideration of communication overhead and synchronization. The interconnectedness of processing cores in a multicore system demands sophisticated communication architectures, like NoCs, to manage the exchange of information without introducing bottlenecks. Balancing the distribution of tasks across cores and minimizing data movement latency is crucial for achieving optimal performance. At the same time, scalability is critical as the computational workload and number of cores increases. Distributing and coordinating clock signals to multiple cores in a power efficient and repeatable manner becomes more difficult with larger networks and workloads.

### SUMMARY

This disclosure relates to multicore processor clock distribution using asynchronous wavefront. A network of computational nodes relies upon timely distribution of a clock signal to maintain data coherency and for proper parallel processing of component computations of complex computations that are processed by the network. In accordance with the present disclosure, a clock signal may be propagated in a wave pattern instead of in a structured zero-skew manner such as an H-tree. Waveform type propagation is based on a known configuration of nodes within the network, for example, which nodes are in direct communication with each other, known or configurable (e.g., via hardware) clock propagation delays between nodes, and available clock signal propagation paths to the furthest node from an initial node or nodes initially receiving the clock signal.

As chips for artificial neural networks employ ever more nodes and associated cores, attempts to distribute a zero-skew clock signal directly to all nodes becomes difficult. In addition, the common point in clock distribution continues to grow farther in time between two leaf points requiring more design margin to account for larger process, voltage and temperature variation. As the chips get bigger, such issues will become more critical. The present disclosure obviates such issues by not requiring a zero-skew signal to be supplied to all the nodes separately, but rather, propagating the clock signal to each node in a predictable and repeatable manner. However, due to the clock signal wave propagation, attention must be paid to the relative timing of data signals that are also exchanged between adjacent nodes. As an example, some nodes (e.g., within a single row with interconnected clock channels having zero clock skew within the row) may have a zero-skew clock with respect to each other and can process data signals normally (e.g., with a fixed buffer delay). When the data is sent along the same direction as the clock wave propagation or in a direction opposite clock wave propagation (e.g., between rows within a common column in either the same or opposite direction as the clock wave propagation), the relative timing of the data and clock signal can be adjusted such as to delay or expedite the data signal relative to a clock transition to avoid hold or setup conditions.

In specific embodiments, the communication circuitry (e.g., receive circuitry) of each of the nodes is programmable so that identical cores can still be used and the programming can be introduced based on the location of the core and the direction of propagation for the clock wave. In this manner, there is no need to design special components or arrangements based on where a node is located within a network and the clock wave propagation, but rather, the nodes can be configured dynamically based on a particular configuration and wave propagation strategy.

In specific embodiments of the invention, a method for wave clock distribution to a network of computational nodes is provided. The method comprises: providing, from a clock source, a clock signal to a subset of nodes of the network of computational nodes; distributing, from each node of the subset of nodes, the clock signal to a respective adjacent node; and propagating, via the adjacent nodes, the clock signal to any additional nodes of the network of computational nodes that are not among the subset of nodes or the adjacent nodes.

In specific embodiments, a system is provided. The system comprises: a network of computational nodes and a clock source that provides a clock signal to a subset of nodes of the network of computational nodes. The clock signal is distributed from each node of the subset of nodes to a respective adjacent node. The clock signal is propagated via the adjacent nodes to any additional nodes of the network of computational nodes that are not among the subset of nodes or the adjacent nodes.

In specific embodiments, a system is provided. The system comprises: a means for providing, from a clock source, a clock signal to a subset of nodes of a network of computational nodes; a means for distributing, from each node of the subset of nodes, the clock signal to a respective adjacent node; and a means for propagating, via the adjacent nodes, the clock signal to any additional nodes of the network of computational nodes that are not among the subset of nodes or the adjacent nodes.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a network of computational nodes in accordance with related art.

FIG. 2 provides an example of a network of computational nodes with waveform clock distribution in accordance with specific embodiments of the inventions disclosed herein.

FIG. 3 provides an example of data exchange and clock distribution between adjacent nodes in accordance with specific embodiments of the inventions disclosed herein.

FIG. 4 provides an example of data exchange and clock wave propagation patterns for a network of computational nodes in accordance with specific embodiments of the inventions disclosed herein.

FIG. 5 provides an example of transmit circuitry of a first node and receive circuitry of a second node in a network of computational nodes having wavefront clock distribution in accordance with specific embodiments of the inventions disclosed herein.

FIG. 6 provides an example of a clock selection in accordance with specific embodiments of the inventions disclosed herein.

FIG. 7 provides an example of a method for wave clock distribution to a network of computational nodes in accordance with specific embodiments of the inventions disclosed herein.

FIG. 8 provides an exemplary network of computational nodes distributing and propagating a clock signal in accordance with specific embodiments of the inventions disclosed herein.

FIG. 9 provides an exemplary network of computational nodes arranged in a circular pattern that distributes and propagates a clock signal in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for multicore processor clock distribution using asynchronous wavefront in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

A network of computational nodes relies upon timely distribution of a clock signal to maintain data coherency and for proper parallel processing of component computations of complex computations that are processed by the network. In accordance with the present disclosure, a clock signal may be propagated in a wave pattern instead of in a structured zero-skew manner such as an H-tree. Waveform type propagation is based on a known configuration of nodes within the network, for example, which nodes are in direct communication with each other, known or configurable (e.g., via hardware) clock propagation delays between nodes, and available clock signal propagation paths to the furthest node from an initial node or nodes initially receiving the clock signal. For example, in a rectangular grid of nodes having a set number of rows and columns the clock signal can initially be provided to two entire rows in a zero-skew fashion, and then propagate along the columns (e.g., vertically between individual nodes of a same column and adjacent rows) one row at a time with known delays for the propagation.

As chips for artificial neural networks employ ever more nodes and associated cores, attempts to distribute a zero-skew clock signal directly to all nodes becomes difficult, with more metal resources diverted to clock distribution at the expense of signal and power routing. In addition, the common point in clock distribution continues to grow farther in time between two leaf points requiring more design margin to account for larger process, voltage and temperature variation. As the chips get bigger, such issues will become more critical. The present disclosure obviates such issues by not requiring a zero-skew signal to be supplied to all the nodes separately, but rather, propagating the clock signal to each node in a predictable and repeatable manner. However, due to the clock signal wave propagation attention must be paid to the relative timing of data signals that are also exchanged between adjacent nodes. As an example, some nodes (e.g., within a single row with interconnected clock channels having zero clock skew within the row) may have a zero-skew clock with respect to each other and can process data signals normally (e.g., with a fixed buffer delay). When the data is sent along the same direction as the clock wave propagation or in a direction opposite clock wave propagation (e.g., between rows within a common column in either the same or opposite direction as the clock wave propagation), the relative timing of the data and clock signal can be adjusted such as to delay or expedite the data signal relative to a clock transition to avoid hold or setup conditions.

In specific embodiments, the communication circuitry (e.g., receive circuitry) of each of the nodes is programmable so that identical cores can still be used and the programming can be introduced based on the location of the core and the direction of propagation for the clock wave. In this manner, there is no need to design special components or arrangements based on where a node is located within a network and the clock wave propagation, but rather, the nodes can be configured dynamically based on a particular configuration and wave propagation strategy.

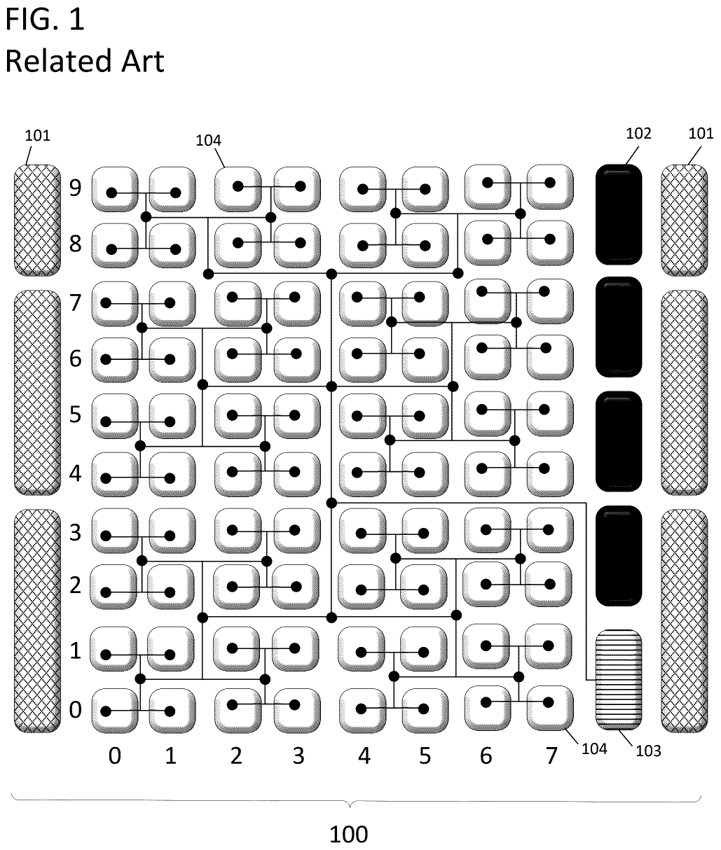

FIG. 1 depicts an exemplary network 100 of computational nodes 104 in accordance with related art. In the example of FIG. 1, the network of computational nodes includes 8 columns of nodes (e.g., labeled 0-7) and 10 rows of nodes (e.g., labeled 0-9) arranged in a rectangular pattern. In addition, network 100 (e.g., contained within a single board and/or chip) also includes shared memory 101, processors 102, and clock source 103 such as a phase locked loop (“PLL”). Each of the nodes 104 includes communication circuitry such as a network interface unit (“NIU”) and router to allow it to exchange data with other nodes 104 within network 100 as well as other components such as shared memory 101 and system processors 102. Each node 104 may further include a processing core that includes one or more processors, which in the context of the present disclosure may be any suitable processor type or combination thereof, such CPUs, graphics processing units (“GPUs”), tensor processing units (“TPUs”), RISC processors, digital signal processors, FPGAs, other processing unit types, and combinations thereof.

FIG. 1 depicts clock source 103, which may be a PLL. In the context of a network (e.g., network 100) of computational nodes performing parallel processing operations, the clock source operates at a high frequency such as in the GHz range. It is thus critical to coordinate data exchange between nodes as well as computational operations with the clock signal, such that data coherency and operational synchronization is maintained throughout the network. As depicted in FIG. 1, one strategy for distributing a clock signal throughout a network of computational nodes (e.g., from a PLL) is using an H-tree configuration. All the nodes are connected to the PLL output via combinations of H-tree connections (clock buffers/inverters) which attempt to collectively eliminate skew between clock signals provided to different nodes, since all of the nodes are connected to the clock source via paths that have balanced propagation delays and zero-skew in view of the H-tree distribution. However, maintaining a zero-skew clock source signal across the entire network (e.g., all nodes/cores within a chip) becomes increasingly difficult as network size increases. In addition, zero-skew across the network can cause L di/dt voltage droop and power-ground ringing, that limit the maximum frequency of the chip without a functional failure. For neighboring nodes and cores on different clock tree branches from the point of divergence, the impact of variation can also be a significant fraction of the clock period, further limiting the operational clock frequency of the chip.

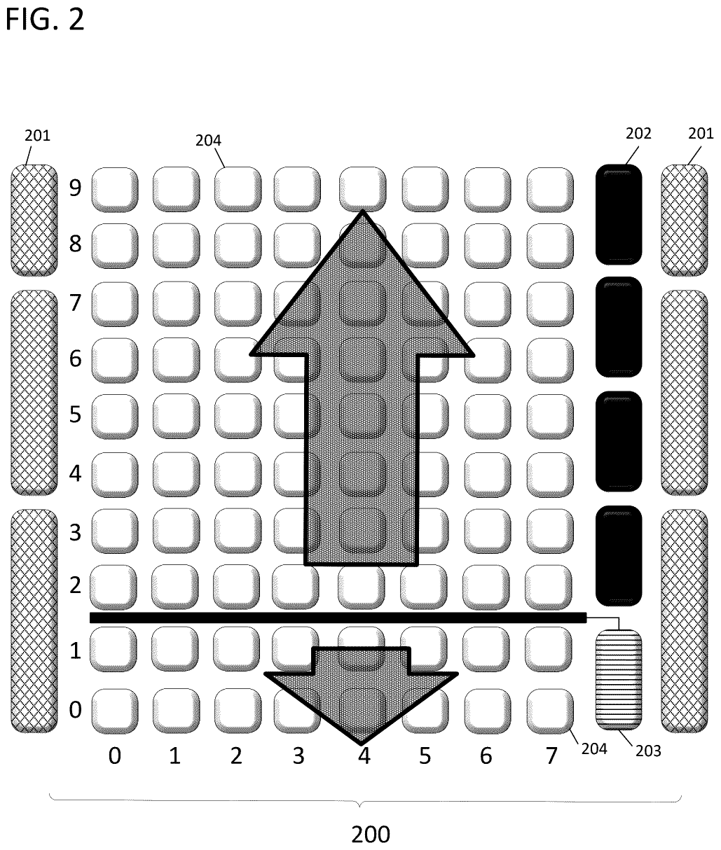

FIG. 2 depicts an exemplary network 200 of computational nodes 204 with wavefront clock distribution in accordance with an embodiment of the present disclosure. Components having the same appearance as components of FIG. 1 may be similar, for example, with 8 columns and 10 rows of computational nodes 204, system memory 201, system processors 202, and clock source 203 (which may be a PLL). It will be understood that the particular combinations of nodes 204, system components, and the like, are exemplary only and the present disclosure may be applied to a variety of configurations. In an embodiment, the components of FIG. 2 may be embodied on a single chip or package, although in some embodiments components may be interconnected in other manners, for example, with a common system clock being propagated to nodes 204 on an adjacent or interconnected chip.

As depicted in FIG. 2, rather than distributing the clock signal in a zero-skew manner such as via H-trees, the clock signal output is initially provided at an initial location with zero skew as a binary clock tree (e.g., to all nodes in rows 1 and 2 in FIG. 2, indicated with thick black line) and then distributed and propagated up and down the rows as depicted by the large arrows of FIG. 2. In this manner, the result is a monotonically increasing clock skew in one dimension, which in the embodiment of FIG. 2, is up and down the rows (e.g., from all nodes 204 in row 2 to adjacent nodes 204 within the same column in row 3, and then propagated to all additional nodes 204 up to row 9 via adjacent nodes 204 in the same columns, and similarly from row 1 to row 0). Accordingly, a multi-driven clock mesh/ladder structure is constructed as a top-level propagating clock wave in the vertical direction.

Although the present disclosure will describe a clock wave that is initially distributed to all nodes within one or two particular rows, and then propagated vertically up and down to adjacent nodes in each next row via adjacent nodes in the same columns, it will be understood that the present disclosure also applies to other clock wave distribution schemes in which an initial clock distribution location (e.g., a node or subset of nodes) and a known or controllable distribution path via adjacent nodes having similar propagation delays is available. For example, instead of a rectangular pattern with linear clock signal distribution and propagation, other configurations such as non-rectangular patterns include a circular pattern, an oval pattern, a polygon pattern, or an irregular pattern. For example, in a “drop of water” configuration the initial clock signal may be provided directly to a central node or a central subset of nodes, and then propagate outward in concentric shapes each corresponding to the propagation of the clock wave to the next adjacent nodes. Moreover, the clock signal may be initially provided to multiple points (e.g., additional rows) to achieve desired propagation patterns.

Distributing and propagating the clock signal as a wave to nodes 204 (e.g., to adjacent and additional nodes) may avoid issues related to distributing a zero-skew clock signal directly to all nodes, such as the common point in a clock distribution growing farther in time between two leaf points and higher design margins to account for larger processes, voltage, and temperature variations. Accordingly, multicore processors and other systems using asynchronous wavefronts for clock signal distribution to nodes 204 may be more reliable and may use lower design margins for processes, voltage, and temperature variations.

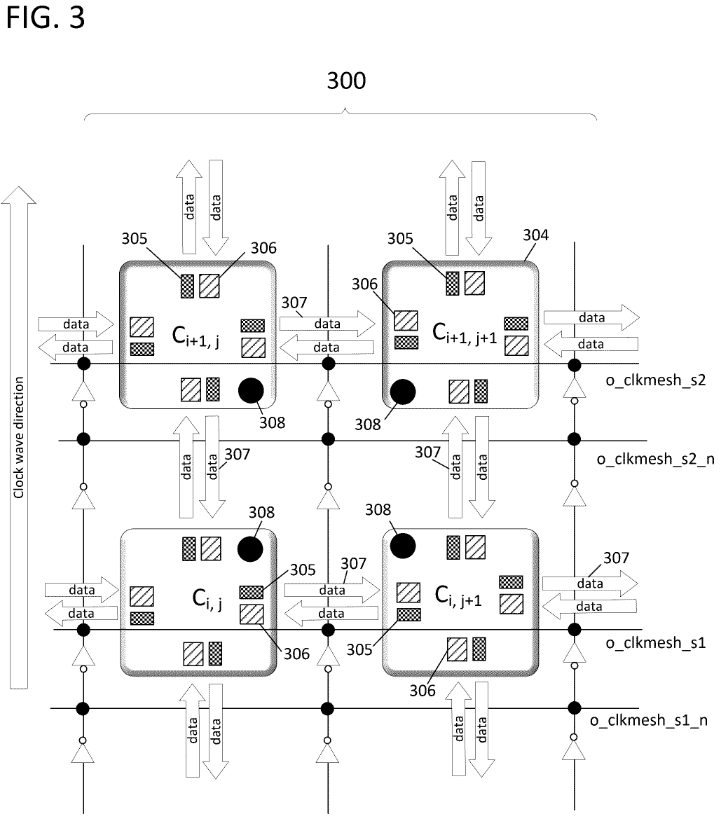

FIG. 3 depicts data exchange and clock distribution between adjacent nodes 304 in in network 300 accordance with an embodiment of the present disclosure. FIG. 3 shows details for a set of four exemplary nodes 304 having a clock wave propagation direction in the upward vertical direction, although it will be understood that similar configurations (e.g., with different orientations of components, etc.) may be applied to different clock wave propagation patterns. Nodes 304 are arranged in a two-dimensional array with the clock wave traveling in a Y-direction while global clock nets are shorted in the X-direction. This ensures zero skew in the X-direction and a fixed known skew in the Y-direction between two neighboring nodes. Accordingly, data flow between Ci,j and Ci,j+1 can happen without any special consideration for clock skew. However, data flow between Ci,j and Ci+1,j requires taking the fixed skew (clock wave propagation delay from row i to row i+1) into account. Shorting the global clock nets in the X-direction keeps the common clock close to the leaf points which reduces the effects of process, voltage and temperature variations.

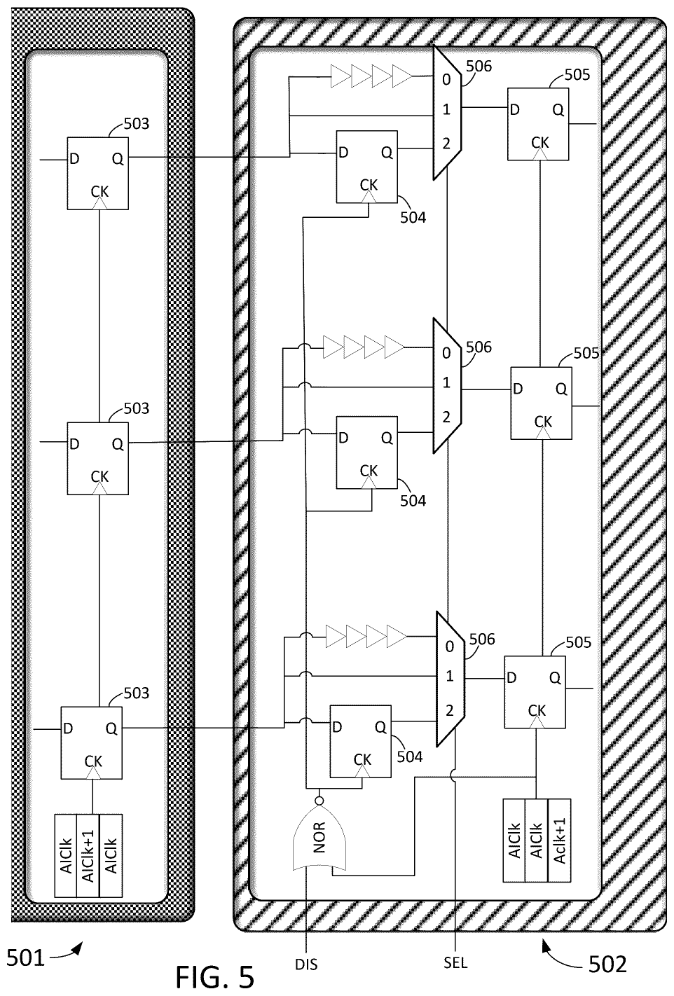

Each of the nodes 304 or cores of FIG. 3 (e.g., nodes/cores Ci,j, Ci,j+1, Ci+1,j, and Ci_1,j+1) has respective transmit circuitry 305 (e.g., depicted as checkered rectangles and depicted in more detail in FIG. 5) and receive circuitry 306 (e.g., depicted with diagonal patterning and depicted in more detail in FIG. 5) and are oriented with respect to each other (e.g., with orientation depicted by black dot 308 in the corner of each node) such that there is a respective data path 307 between each adjacent node 304 via its associated transmit circuitry 305 and receive circuitry 306. It will be noted that some of the data paths 307 are located along one of the interconnected zero-skew channel lines. For example, the data path between nodes C_{i,j} and C_{i,j+1} and the data path between nodes C_{i+1,j} and C_{i+1,j+1} are located along interconnected zero-skew channel lines o_clkmesh_s1 and o_clkmesh_s2, respectively. Accordingly, data transmitted between these nodes is handled by nodes that have the same clock signal with zero skew.

Communications between other nodes that are not within the same row/channel can either be in the direction of the clock wave propagation (e.g., vertically upwards in FIG. 3) or in the opposite direction of the clock wave propagation (e.g., vertically downwards in FIG. 3). For example, data communications from node C_{i,j} to C_{i+1,j} and from C_{i,j+1} to C_{i+1,j+1} are in the direction of the clock wave propagation, while data communications from node C_{i+1,j} to C_{i,j} and from C_{i+i,j+1} to C_{i,j+1} are in the opposite direction as clock wave propagation.

Data communications between adjacent nodes may propagate in a known manner (e.g., requiring two clock cycles or another known value) such that the transmit and/or receive circuitry is configured to selectively apply different timing operations to a received data signal based on the respective direction of transmission with respect to the clock wave: (1) orthogonal to clock wave (e.g., zero-skew condition within rows); (2) in direction of clock wave (e.g., between rows in direction of clock wave propagation); and (3) opposite direction of clock wave (e.g., between rows opposite the direction of the clock wave). For example, buffers and other circuitry (e.g., flip-flops) may be implemented to achieve appropriate relative timing between the data and clock signals and limit or mitigate hold risk or setup risk due to data and clock signal mismatch or interactions.

In an example of data transmission orthogonal to a clock wave, a predetermined buffering may be implemented to avoid hold risk, as may be done in other zero-skew situations. In an example of data transmission in a direction of a clock wave propagation, negative edge flops may be inserted to mitigate hold risk. In an example of data transmission in an opposite direction of the clock wave propagation, a limited delay or no delay may be necessary. In some embodiments, each of these options may be included within the transmit and/or receive circuitry and are selectable based on the particular configuration and orientation of the circuitry with respect to an adjacent node and the clock wave propagation. In this manner, clock wave propagation may be utilized without requiring different permutations or specialty hardware within each node based on location and orientation, and nodes within chips may be dynamically reconfigured as necessary based on changes in clock wave propagation patterns.

Distributing and propagating the clock signal as a wave between nodes 304 may avoid issues related to distributing a zero-skew clock signal directly to all nodes. Accordingly, multicore processors and other systems using asynchronous wavefronts for clock signal distribution to nodes 304 and via nodes 304 may be more reliable and may use lower design margins for processes, voltage, and temperature variations.

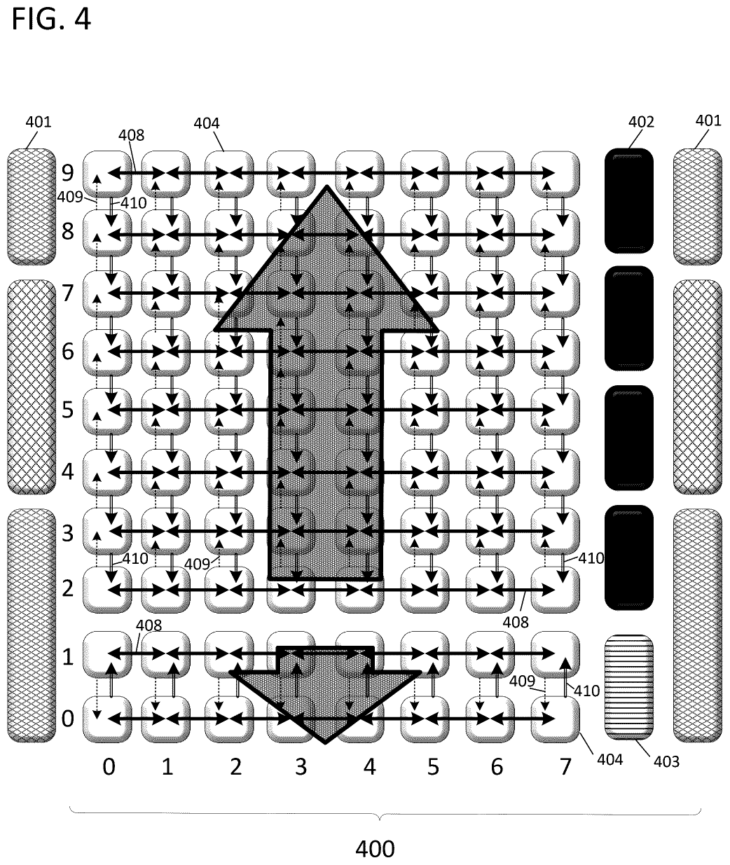

FIG. 4 depicts data exchange and clock wave propagation patterns for network 400 of computational nodes 404 in accordance with an embodiment of the present disclosure. FIG. 4 includes computational nodes 404, system memory 401, system processors 402, and clock signal source 403. FIG. 4 is generally identical to FIG. 2, except in FIG. 4 the sets of smaller arrows represent different data transmission for different clock wave propagation conditions. For clarity, connections between nodes referring to clock signals have been omitted and clock wave propagation direction is indicated by the large arrows. Between rows 1 and 2 the clock signal source 403 (e.g., a PLL) provides the clock signal to each nodes 404 in rows 1 and 2, such that each nodes 404 in rows 1 and 2 receives a zero-skew clock signal to propagate downward or upward respectively through the remaining rows with known delay and/or skew.

Data signal paths 408 along rows are indicated with thick, black arrows. Data signal paths 408 travel perpendicular to the clock wave propagation (indicated by large, central, vertical arrows). Accordingly, each node 404 in a row may have zero skew clock signals relative to each other node 404 in the row. The system (e.g., nodes along data signal paths 408) may buffer data signals that travel along rows of nodes. Data transmissions within each row have zero skew and the borders between nodes are configured accordingly.

Dotted arrows in FIG. 4 correspond to data signal paths 409 traveling in the same direction as the clock wave propagation, for example, with data signal paths 409 indicating a direction away from rows 1 and 2 (where rows 1 and 2 contain the nodes that received the initial clock signal from clock signal source 403). Data received via the adjacent rows (e.g., rows 0 and 3 through 9) is being sent in the direction of clock wave propagation, and thus, the transmit and/or receive circuitry between these rows (e.g., from row 2 to row 3, from row 3 to row 4, from row 4 to row 5, from row 5 to row 6, from row 6 to row 7, from row 7 to row 8, from row 8 to row 9, and from row 1 to row 0) is configured for such conditions. For example, these nodes may delay a data signal traveling along data signal path 409. The system (e.g., nodes along the data signal paths 409) may delay a data signal traveling in the same direction as the clock signal.

Finally, data transmitted along data signal paths 410 in a direction opposite that of the clock wave propagation are depicted with double-lined arrows. For example, data signal paths 410 from row 3 to row 2, from row 4 to row 3, from row 5 to row 4, from row 6 to row 5, from row 7 to row 6, from row 8 to row 7, from row 9 to row 8, and from row 0 to row 1 travel opposite the direction of the clock wave propagation. Data received via the adjacent row (e.g., rows 1 through 8) is being sent opposite the direction of clock wave propagation, and thus, the transmit and/or receive circuitry between these rows is configured for such conditions. For example, the data signal may not be delayed (e.g., the nodes may refrain from delaying the signal).

Distributing and propagating the clock signal as a wave to nodes 404 (e.g., to adjacent and additional nodes) may avoid issues related to distributing a zero-skew clock signal directly to all nodes. The clock signal is propagated to each node 404 in a predictable and repeatable manner and the relative timing of clock signals and data signals exchanged between adjacent nodes 404 is adjusted. For example, the data signal may be delayed or expediated relative to a clock transition to avoid hold or setup conditions. Accordingly, multicore processors and other systems using asynchronous wavefronts for clock signal distribution to nodes 404 may be more reliable and may use lower design margins for processes, voltage, and temperature variations.

FIG. 5 depicts exemplary transmit circuitry of a first node 501 (e.g., checkered to conform to the transmit circuitry of FIG. 3) and receive circuitry of a second node 502 (e.g., depicted in diagonal lines to conform to the receive circuitry of FIG. 3) for computational nodes having wavefront clock distribution in accordance with an embodiment of the present disclosure. Although particular components such as flops, buffers, gates, multiplexers, and the like are depicted in FIG. 5, it will be understood that the functionality described for FIG. 5 may be implemented with other circuitry performing similar operations (e.g., delay, hold, launch, capture, etc.), either alone or in combination. Moreover, although certain hardware and circuitry is depicted as being on a transmit or receive side of the data communications, some aspects or portions of the circuitry may be moved between the respective transmit or receive circuitry.

In specific embodiments an operating mode for node 502 may be selected based on whether data reception for each node is in a direction of the distributing and propagating of the clock signal. In specific embodiments, each operating mode for each of the nodes may be selected (multiplexer 506 input “0”) from a set of operating modes including a first mode, a second mode, and a third mode. The first mode may be selected in a first situation where adjacent nodes have a clock signal with zero skew. The second mode may be selected (multiplexer 506 input “1”) in a second situation where the data reception for the node is in an opposite direction as the distributing and propagating. The third mode may be selected (multiplexer 506 input “2”) in a third situation where the data reception for the node is in the direction of the distributing and propagating.

As described herein, the data communication circuitry implementing the nodes of the present disclosure may be interchangeable whether the data signal is transmitted between nodes having a zero-skew clock signal (e.g., within a common row between columns as depicted herein), transmitted in the direction of the propagation of the clock wave (e.g., vertically between rows within a column in the direction of clock wave propagation), or transmitted opposite the direction of the propagation of the clock wave (e.g., vertically between rows within a column opposite the direction of clock wave propagation). Accordingly, a clock signal during a transfer of data from first node 501 and second node 502 can be “AlClk” at both nodes 501 and 502 corresponding to a zero-skew condition (e.g., left clock input at the bottom of each node), “AlClk+1” on the transmit node 501 and “AlClk” on the receive node 502 may correspond to the data and clock moving in the opposite directions (e.g., middle clock input to each node, corresponding to the clock wave propagating from node 502 to node 501 and data being transmitted from node 501 to node 502), and “AlClk” on the transmit node 501 and “AlClk+1” on the receive node 502 may correspond to the data and clock moving in the same directions (e.g., right clock input to each node, corresponding to the clock wave propagating from node 501 to node 502 and data being transmitted from node 501 to node 502). The notation AlClk+1 in this description and drawings is indicative of a unit delay for clock wave propagation, such as approximately 100 ps at exemplary clocking speeds.

A first situation or operating mode that may occur is where the transmit/launch clock and the receive/capture clocks are matched, for example, when there is zero skew between the clock signals at the node 501 and 502 because they have the same directly interconnected clock such as within a row of the network of computational nodes (e.g., transmissions in either direction between nodes C_{i,j} and C_{i,j+1} in FIG. 3, or in either direction between nodes C_{i+1,j} and C_{i+1,j+1} in FIG. 3). In this situation, a delay such as with buffers may be utilized to mitigate hold risk (e.g., similar to the default setting for other zero-skew clock situations). Accordingly, the data is clocked out on a clock transition from the D-flop 503 from the transmit/launch circuitry of node 501 (depicted as three data lines for illustration only, although other numbers of data lines may be utilized in other implementations) to each of three optional circuit paths within each of three corresponding sets of receive circuitry. In a matched clock situation, the select input “SEL” is a value such as “00” corresponding to output “0” from each multiplexers 506. Accordingly, the data path at the receive/capture side is via the buffers to the D capture flops 505 to the right of node 502 via the “0” selection of multiplexer 506, with the data being clocked into additional circuitry of the corresponding node 502 on the next clock cycle at the right-side D flops 505 connected via multiplexers 506.

A second situation or operating mode that may occur is where the transmit/launch clock is delayed in comparison to the receive/capture clock, for example, when the clock wave is propagating opposite the direction of data transmission (e.g., clock wave propagation from node 502 to node 501 with clock signal AlClk+1 at node 501 and clock signal AlClk at node 502). As an example, this situation may occur for data transmissions such as from node C_{i+1,j} to C_{i,j} or from node C_{i+1,j+1} to node C_{i,j+1} in FIG. 3. In this situation, there may be no buffers or a reduced number of buffers to mitigate setup risk (a direct connection with no buffers depicted in FIG. 5), corresponding to a value of the SEL input such as “01” selecting output 1 from each multiplexer 506. The data is clocked out on a clock transition from the D launch flop 503 from the transmit/launch circuitry of node 501 (depicted as three data lines for illustration only, although other numbers of data lines may be utilized in other implementations) to the D capture flops 505 at the right side of node 502 via the “1” selection of multiplexer 506, with the data being clocked into additional circuitry of the corresponding node 502 on the next clock cycle at the D capture flops 505 connected via multiplexers 506.

A third situation or operating mode that may occur is where the receive/capture clock is delayed in comparison to the transmit/launch clock, for example, when the clock wave is propagating in the direction of data transmission (e.g., clock wave propagation from node 501 to node 502 with clock signal AlClk at node 501 and clock signal AlClk+1 at node 502). As an example, this situation may occur for data transmissions such as from node C_{i,j} to C_{i+1,j} or from node C_{i,j+1} to C_{i+1,j+1} in FIG. 3. In this situation, a hold risk is mitigated by negative edge D flops 504 at the input to selection 2 on each of the multiplexers of node 502. Accordingly, the input data signal is held at the D flops 504 based on the input clock AlClk+1 and provided to multiplexer 506 at input “2” corresponding to a SEL input such as “10”. The data is clocked out on a clock transition from the D launch flop 503 from the transmit/launch circuitry of node 501 (depicted as three data lines for illustration only, although other numbers of data lines may be utilized in other implementations) to the D flops 504 at the left side of node 502 and as inputs to the multiplexer input 2, and from those flops 504 to the D capture flops 505 via the “2” selection of multiplexer 506, with the data being clocked into additional circuitry of the corresponding node 502 on the next clock cycle at the D capture flops 505.

Even if they are not in use, the left-side D flops 504 of node 502 may still need to be clocked such as during power up sequences, e.g., based on input DIS set to a “0” value to the NOR gate that provides an input to the CK inputs of the flops 504, allowing the clock to initially ensure these negative edge flip flops 504 are initialized to a known value. The DIS input may be set to 1 during the first and second conditions (e.g., matched clock or opposite-direction clock wave and data corresponding to select inputs 00 and 01) and to 0 during the third situation where data is provided via flops 504.

Returning to FIG. 4, a network on chip (“NoC”) interface may be provided for each row. Within each row, communications may be zero skew as described herein. In order to properly be configured for both data transmissions in the direction of clock wave propagation and in the direction of opposite clock wave propagation, one DIS control bit and two SEL control bits may be provided at each horizontal NOC interface, i.e., to selectively configure the respective interfaces of the nodes (e.g., as depicted in FIG. 4, by dotted and double-lined lines/arrows). Because of the controlled and known nature of clock wave distribution, the configuration can thus be performed for a complete horizontal NoC interface with a limited number of control bits such as 6 bits (e.g., 2 DIS and 4 SEL).

Distributing and propagating the clock signal as a wave to nodes in a network including nodes 501 and 502 may avoid issues related to distributing a zero-skew clock signal directly to all nodes. The clock signal is propagated to node 501 and node 502 in a predictable and repeatable manner and the relative timing of clock signals and data signals exchanged between adjacent nodes 501 and 502 is adjusted based on the relative directions of the clock signal and data signal propagations. For example, the data signal may be delayed or expediated relative to a clock transition to avoid hold or setup conditions. Accordingly, multicore processors and other systems using asynchronous wavefronts for clock signal distribution to nodes may be more reliable and may use lower design margins for processes, voltage, and temperature variations than systems dependent on zero skew clock signals to all nodes.

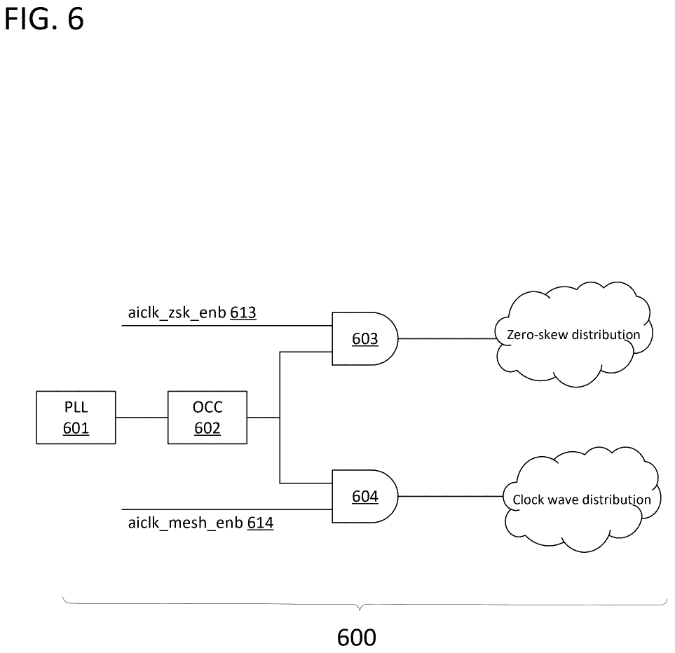

FIG. 6 depicts exemplary clock selection 600 in accordance with an embodiment of the present disclosure. In some cases, it may be desirable to implement post-silicon controllability between zero-skew clock distribution and clock wave distribution. Accordingly, the clock mesh/ladder may be constructed in addition to the default zero-skew clock distribution (H-tree/spine). As depicted in FIG. 6, a clock source such as PLL 601 provides a clock signal to circuitry such as an on chip controller (“OCC”) 602, which in turn distributes the system clock system to two AND gates 603 and 604 that are respectively controlled by inputs aiclk_zsk_enb 613 (to enable zero skew clock distribution) and aiclk_mesh_enb 614 (to enable clock wave distribution). In this manner, both clock distribution options share a common clock root. Only one of these two clocks is enabled at clock root using enable bits (aiclk_mesh_enb 614 and aiclk_zsk_enb 613) which are post-silicon controllable. In some examples, when switching from one clock to another, first both enables must be de-asserted for a sufficient number of reference clock cycles (e.g., 10) before turning-on the other enable. In some implementations, prior to final shipping of parts, the enable bits may fused (e.g., hard-wired) to either logic level based on the implementation for a particular end-use application.

In specific embodiments, the communication circuitry of each of the nodes is programmable so that identical cores can still be used and the programming can be introduced based on the location of the core and the direction of propagation for the clock wave. In this manner, there is no need to design special components or arrangements based on where a node is located within a network and the clock wave propagation, but rather, the nodes can be configured dynamically based on a particular configuration and wave propagation strategy.

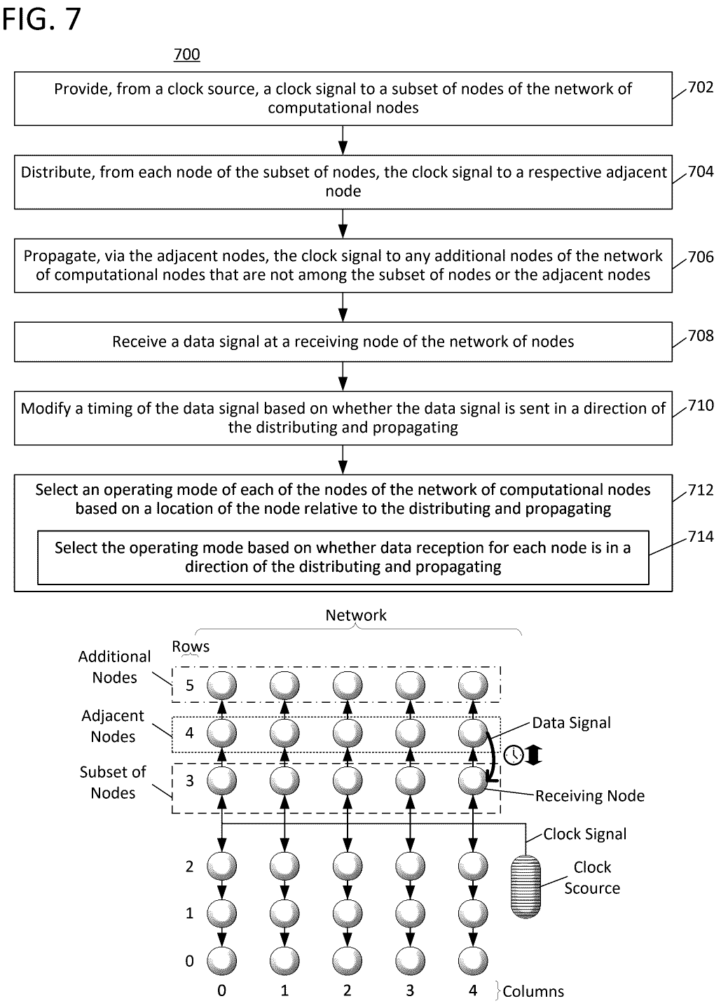

FIG. 7 depicts an example of method 700 for wave clock distribution to a network of computational nodes. Method 700 may be performed by a system including a network of computational nodes and a clock source. Method 700 may be performed by any system having a means for performing steps 702 through 706, and in specific embodiments, steps 702 through 714. Steps or portions of steps of method 700 may be duplicated, omitted, rearranged, or otherwise deviate from the form shown.

At step 702, a clock signal may be provided from a clock source to a subset of nodes of a network of computational nodes. In specific embodiments, the network of computational nodes comprises a plurality of rows and a plurality of columns arranged in a rectangular pattern, where the subset of nodes is arranged in one or more of the plurality of rows. In specific embodiments, the network of nodes is arranged in a non-rectangular pattern, such as a circular pattern, an oval pattern, a polygon pattern, or an irregular pattern. In specific embodiments, the clock source may comprise a phase locked loop (PLL).

At step 704, the clock signal may be distributed from each node of the subset of nodes to a respective adjacent node. In specific embodiments where the network of nodes is arranged in a rectangular pattern, distributing the clock signal occurs along each row via the plurality of columns. In specific embodiments, the subset of nodes may include two adjacent rows and distributing the clock signal may occur upward along the plurality of columns from a first row of the two adjacent rows and distributing the clock signal may occur downward along the plurality of columns from a second row of the two adjacent rows. In specific embodiments, distributing the clock signal occurs along the plurality of columns such that each node within each row of nodes receives the clock signal synchronously. In specific embodiments where the network of nodes is arranged in a non-rectangular pattern, the respective adjacent nodes receive the clock signal synchronously.

At step 706, the clock signal may be propagated via the adjacent nodes to any additional nodes of the network of computational nodes that are not among the subset of nodes or the adjacent nodes (e.g., all the nodes that have not already received the clock signal). In specific embodiments where the network of nodes is arranged in a rectangular pattern, propagating the clock signal occurs along each row via the plurality of columns. In specific embodiments, the subset of nodes may include two adjacent rows and propagating the clock signal may occur upward along the plurality of columns from a first row of the two adjacent rows and propagating the clock signal may occur downward along the plurality of columns from a second row of the two adjacent rows. In specific embodiments, propagating the clock signal occurs along the plurality of columns such that each node within each row of nodes receives the clock signal synchronously. During propagating, in specific embodiments where the network of nodes is arranged in a non-rectangular pattern, each of the additional nodes may receive the clock signal synchronously with other of the additional nodes based on a number of nodes the clock signal propagates through from one of the respective adjacent nodes

In specific embodiments, at step 708, a data signal may be received at a receiving node of the network of nodes. In specific embodiments, when the clock signal at the receiving node is the same clock signal as at a sending node, the data signal is buffered.

In specific embodiments, at step 710, a timing of the data signal may be modified based on whether the data signal is sent in a direction of the distributing and propagating. In specific embodiments, when the data signal is sent in a same direction as the distributing and propagating, the data signal is delayed. In specific embodiments, when the data signal is sent in an opposite direction as the distributing and propagating, the data signal is not delayed.

In specific embodiments, at step 712, an operating mode of each of the nodes of the network of computational nodes may be selected. The operating mode may be selected based on a location of the node relative to the distributing and propagating.

In specific embodiments, at step 714 and as part of selecting the operating mode (step 712), the operating mode may be selected based on whether data reception for each node is in a direction of the distributing and propagating. In specific embodiments, each operating mode for each of the nodes may be selected from a set of operating modes including a first mode, a second mode, and a third mode. The first mode may be selected when the data reception for the node is in the direction of the distributing and propagating. The second mode may be selected when the data reception for the node is in an opposite direction as the distributing and propagating. The third mode may be selected when adjacent nodes have a clock signal with zero skew.

The system that performs method 700 may include a variety of structures to perform the functions of the steps described. For example, providing a clock signal to a subset of nodes of the network of computational nodes may be performed by wires, cables, wireless technology, certain protocols such as PCIe, Ethernet, and BOW, routers, switches, radio, vias, or busses. Distributing the clock signals to respective adjacent nodes may also be performed by wires, cables, wireless technology, certain protocols such as PCIe, Ethernet, and BOW, routers, switches, radio, vias, or busses. Propagating the clock signal to any additional nodes may also be performed by wires, cables, wireless technology, certain protocols such as PCIe, Ethernet, and BOW, routers, switches, radio, vias, or busses. Receiving a data signal at a receiving node may be performed by a receiver, port, or antenna. Modifying a timing of the data signal may be performed by a latch, queue, or delay circuit. Selecting an operating mode of each of the nodes of the network may be performed by a processor, central processing unit (CPU), core, controller, or microcontroller. These means or structures are exemplary only and steps of method 700 may also be performed by devices, structures, and systems not listed or a combination of structures.

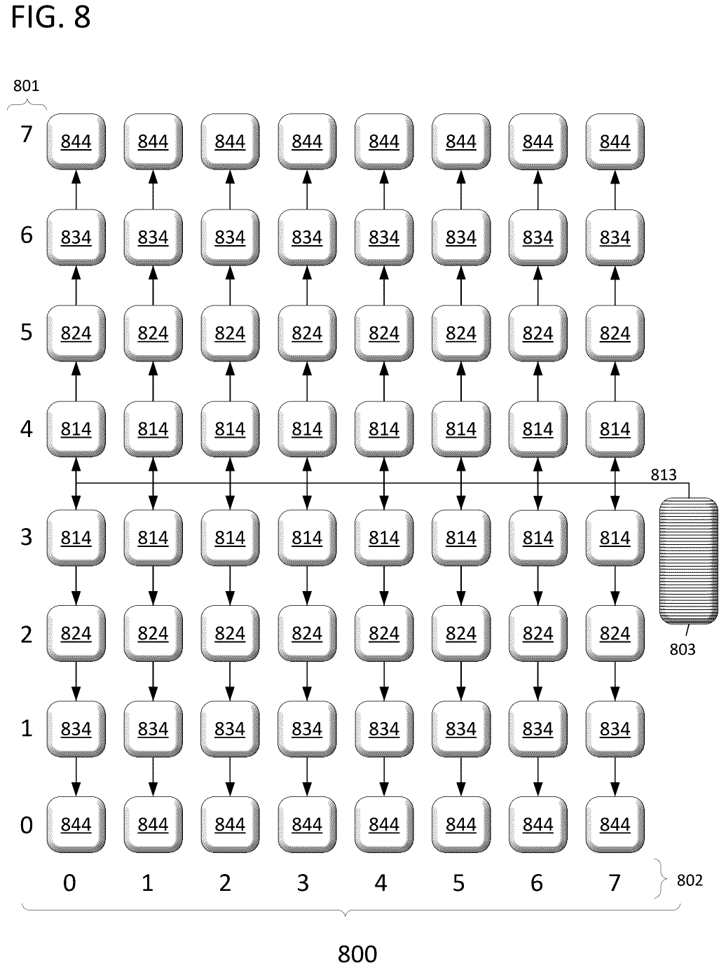

FIG. 8 depicts an exemplary network 800 of computational nodes 814, 824, 834, and 844 distributing and propagating clock signal 813 in accordance with an embodiment of the present disclosure. FIG. 8 includes eight rows 801 of nodes (numbered 0-7), eight columns 802 of nodes (numbered 0-7), and clock source 803 (which may be a PLL). It will be understood that the particular combinations of nodes, system components, and the like, are exemplary only and the present disclosure may be applied to a variety of configurations including more or less rows/columns of nodes or a non-rectangular arrangement of nodes. In an embodiment, the components of FIG. 8 may be embodied on a single chip or package, although in some embodiments components may be interconnected in other manners, for example, with a common system clock being propagated to nodes on an adjacent or interconnected chip.

As depicted in FIG. 8, rather than distributing the clock signal in a zero-skew manner such as via H-trees, the clock signal 813 is initially provided with zero skew to all nodes 814 and then distributed and propagated up and down rows 801 in a given column 802 from nodes 814 to nodes 824, from nodes 824 to nodes 834, and from nodes 834 to nodes 844 (as depicted by the arrows). In this manner, the result is a monotonically increasing clock skew in one dimension, which in the embodiment of FIG. 8, is up and down the rows. Accordingly, a multi-driven clock mesh/ladder structure is constructed as a top-level propagating clock wave in the vertical direction.

Clock source 803 may provide clock signal 813 to initial nodes 814 (e.g., a subset of nodes) in network 800. Clock signal 813 may be distributed from each node 814 to adjacent nodes 824. After being distributed to adjacent nodes 824, clock signal 813 may be propagated to additional nodes 834 and 844 via nodes 824. For example, clock signal 813 may be propagated to nodes 834 via nodes 824 and to nodes 844 via nodes 834. In specific embodiments, columns 802 of nodes may be chained together such that clock signal 813 is the same for a given row 801. The distributing and propagating of clock signal 813 may occur along each row 801 via the plurality of columns 802.

Rows 3 and 4 may be adjacent rows 801 that each include nodes 814. The distributing and propagating of clock signal 813 may occur upward along the plurality of columns 802 from Row 4 and may occur downward along the plurality of columns 802 from a Row 3. In specific embodiments, the distributing and propagating of clock signal 813 may occur along the plurality of columns 802 such that each node within each row 801 of nodes receives clock signal 813 synchronously. That is, each node 814 receives clock signal 813 synchronously, each node 824 receives clock signal 813 synchronously, each node 834 receives clock signal 813 synchronously, and each node 844 receives clock signal 813 synchronously. However, rows 801 in general may receive clock signal 813 at different times (e.g., clock signal 813 at nodes 814 may be nonsynchronous with clock signal 813 at nodes 824, which may be nonsynchronous with nodes 834, which may be nonsynchronous with nodes 844).

Various nodes of FIG. 8 may act as receiving nodes and may receive one or more data signals. The timing of the data signals may be based on whether the data signal is sent in a direction of the distributing and propagating of clock signal 813 (arrows of FIG. 8). For example, when the data signal is sent in the same direction (e.g., from node 824 to corresponding node 834) as the distribution and propagation of clock signal 813, the data signal may be delayed. If the data signal is sent in an opposite direction (e.g., from node 834 to corresponding node 824) as the distribution and propagation of clock signal 813, the data signal may not be delayed (e.g., the system may refrain from delaying the data signal via delay circuits, flops, buffers, etc.). If the clock signal 813 at the receiving node is the same clock signal as the clock signal 813 at the receiving node (e.g. the data signal is transmitted between two nodes 824), then the data signal may be buffered.

An operating mode of a node may control the presence and duration of a delay of the data signal. Selecting an operating mode of each of the nodes of network 800 may be based on the location of the node relative to the distribution and propagation of clock signal 813. Selecting the operating mode of each of the nodes may include selecting the operating mode based on whether data reception for each node is in a direction of the distribution and the propagation of clock signal 813. The operating mode may be selected from a set of operating modes including a first mode when the data reception for the node is in the direction of the distributing and propagating (e.g., from node 814 to corresponding node 824), a second mode when the data reception for the node is in an opposite direction as the distributing and propagating (e.g., from node 824 to corresponding node 814), and a third mode when adjacent nodes have a clock signal with zero skew (e.g., from node 834 to another node 834).

In specific embodiments, instead of a rectangular pattern with linear clock signal distribution and propagation as shown in FIG. 8, nodes may be arrange in other configurations such as non-rectangular patterns include a circular pattern, an oval pattern, a polygon pattern, or an irregular pattern. When the network of nodes is arranged in a non-rectangular pattern, the respective adjacent nodes may still receive the clock signal synchronously, and, during the propagation of the clock signal, each of the additional nodes may receive the clock signal synchronously with other of the additional nodes based on a number of nodes the clock signal propagates through from one of the respective adjacent nodes. For example, in a “drop of water” configuration the initial clock signal may be provided directly to a central node or a central subset of nodes, and then propagate outward in concentric shapes each corresponding to the propagation of the clock wave to the next adjacent nodes. Moreover, the clock signal may be initially provided to multiple points (e.g., additional rows) to achieve desired propagation patterns.

Distributing and propagating clock signal 813 as a wave or chain to initial nodes 814 then to adjacent nodes 824 then to additional nodes 834 then to additional nodes 844 may avoid issues related to distributing a zero-skew clock signal directly to all nodes, such as the common point in a clock distribution growing farther in time between two leaf points and higher design margins to account for larger processes, voltage, and temperature variations. Accordingly, multicore processors and other systems using asynchronous wavefronts for clock signal distribution to nodes shown in FIG. 8 may be more reliable and may use lower design margins for processes, voltage, and temperature variations.

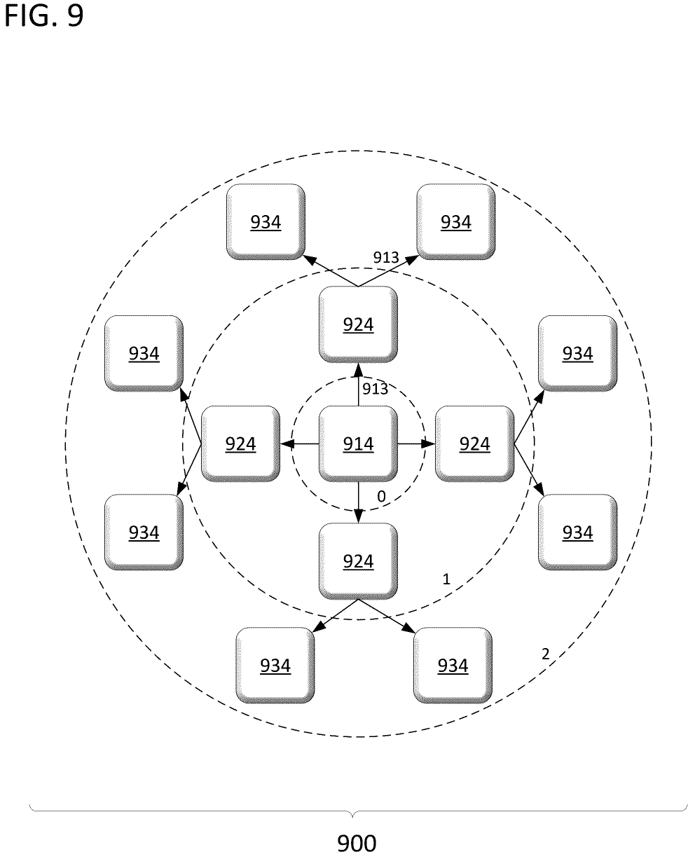

FIG. 9 depicts an exemplary network 900 of computational nodes 914, 924, and 934 arranged in a circular pattern distributing and propagating clock signal 913 in accordance with an embodiment of the present disclosure. Network 900 includes three rings of nodes (numbered 0-2) and clock signal 913. It will be understood that the particular combinations of nodes, system components, and the like, are exemplary only and the present disclosure may be applied to a variety of configurations including more or less rings of nodes or a different geometric or non-geometric arrangement of nodes. In an embodiment, the components of FIG. 9 may be embodied on a single chip or package, although in some embodiments components may be interconnected in other manners, for example, with a common system clock being propagated to nodes on an adjacent or interconnected chip.

Rather than distributing the clock signal in a zero-skew manner such as via H-trees, FIG. 9 depicts a “drop of water” configuration where the initial clock signal 913 is provided directly to central node 914 and then propagates outward in concentric rings (e.g., Ring 0 to Ring 1 to Ring 2) each corresponding to the propagation of the clock wave to the next adjacent nodes, as depicted by the arrows (although other distribution arrangements are possible). In this manner, the result is a monotonically increasing clock skew in an outward dimension. Accordingly, a multi-driven clock system is constructed as a top-level propagating clock wave in the outward direction.

A clock source may provide clock signal 913 to initial node 914 (e.g., a subset of nodes) in network 900. Clock signal 913 may be distributed from node 914 to adjacent nodes 924. After being distributed to adjacent nodes 924, clock signal 913 may be propagated to additional nodes 934 via nodes 924. In specific embodiments, rings of nodes may be chained together such that clock signal 913 is the same for a given ring.

In specific embodiments, the distributing and propagating of clock signal 913 may occur such that each node within each ring receives clock signal 913 synchronously. That is, each node 924 receives clock signal 913 synchronously, and each node 934 receives clock signal 813 synchronously. However, rings in general may receive clock signal 913 at different times (e.g., clock signal 913 at node 914 may be nonsynchronous with clock signal 913 at nodes 924, which may be nonsynchronous with nodes 934).

Various nodes of FIG. 9 may function as receiving nodes and may receive one or more data signals. The timing of the data signals may be based on whether the data signal is sent in a direction of the distributing and propagating of clock signal 913 (arrows of FIG. 9). For example, when the data signal is sent in the same direction (e.g., from node 924 to a corresponding node 934) as the distribution and propagation of clock signal 913, the data signal may be delayed. If the data signal is sent in an opposite direction (e.g., from node 934 to corresponding node 924) as the distribution and propagation of clock signal 813, the data signal may not be delayed (e.g., the system may refrain from delaying the data signal via delay circuits, flops, buffers, etc.). If clock signal 913 at the receiving node is the same clock signal as clock signal 913 at the receiving node (e.g. the data signal between is transmitted between two nodes 924), then the data signal may be buffered.

Distributing and propagating clock signal 913 as a wave to initial node 914 then to adjacent nodes 924 then to additional nodes 934 may avoid issues related to distributing a zero-skew clock signal directly to all nodes, such as the common point in a clock distribution growing farther in time between two leaf points and higher design margins to account for larger processes, voltage, and temperature variations. Accordingly, multicore processors and other systems using asynchronous wavefronts for clock signal distribution to nodes shown in FIG. 9 may be more reliable and may use lower design margins for processes, voltage, and temperature variations.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, the example of cores in a multicore processor was provided as an example of the computational units to which the clock could be distributed using the approaches disclosed herein. However, similar approaches can be used to distribute clock signals to any form of nodes in a network of computational nodes. Any of the method steps discussed above can be conducted by a processor operating with a computer-readable non-transitory medium storing instructions for those method steps. The computer-readable medium may be memory within a personal user device or a network accessible memory. These and other modifications and variations to the present invention may be practiced by those skilled in the art, without departing from the scope of the present invention, which is more particularly set forth in the appended claims.

What is claimed is:

1. A method for wave clock distribution to a network of computational nodes, comprising:
providing, from a clock source, a clock signal to a subset of nodes of the network of computational nodes;
distributing, from each node of the subset of nodes, the clock signal to a respective adjacent node; and
propagating, via the adjacent nodes, the clock signal to any additional nodes of the network of computational nodes that are not among the subset of nodes or the adjacent nodes.

2. The method of claim 1, wherein the network of computational nodes comprises a plurality of rows and a plurality of columns arranged in a rectangular pattern, wherein the subset of nodes is arranged in one or more of the plurality of rows, and wherein the distributing and propagating occur along each row via the plurality of columns.

3. The method of claim 2, wherein the subset of nodes includes two adjacent rows, and wherein the distributing and propagating occur upward along the plurality of columns from a first row of the two adjacent rows and wherein the distributing and propagating also occur downward along the plurality of columns from a second row of the two adjacent rows.

4. The method of claim 2, wherein the distributing and propagating occur along the plurality of columns such that each node within each row of nodes receives the clock signal synchronously.

5. The method of claim 1, wherein the network of nodes is arranged in a non-rectangular pattern, wherein the respective adjacent nodes receive the clock signal synchronously, and wherein, during the propagating, each of the additional nodes receives the clock signal synchronously with other of the additional nodes based on a number of nodes the clock signal propagates through from one of the respective adjacent nodes.

6. The method of claim 5, wherein the non-rectangular pattern comprises a circular pattern, an oval pattern, a polygon pattern, or an irregular pattern.

7. The method of claim 1, further comprising:
receiving a data signal at a receiving node of the network of nodes; and
modifying a timing of the data signal based on whether the data signal is sent in a direction of the distributing and propagating.

8. The method of claim 7, wherein, when the data signal is sent in a same direction as the distributing and propagating, the data signal is delayed.

9. The method of claim 8, wherein, when the data signal is sent in an opposite direction as the distributing and propagating, the data signal is not delayed.

10. The method of claim 9, wherein, when the clock signal at the receiving node is a same clock signal as at a sending node, the data signal is buffered.

11. The method of claim 1, further comprising selecting an operating mode of each of the nodes of the network of computational nodes based on a location of the node relative to the distributing and propagating.

12. The method of claim 11, wherein selecting the operating mode of each of the nodes comprises selecting the operating mode based on whether data reception for each node is in a direction of the distributing and propagating.

13. The method of claim 12, wherein the operating mode is selected from a set of operating modes comprising a first mode when the data reception for the node is in the direction of the distributing and propagating, a second mode when the data reception for the node is in an opposite direction as the distributing and propagating, and a third mode when adjacent nodes have a clock signal with zero skew.

14. The method of claim 1, wherein the clock source comprises a phase locked loop.

15. A system comprising:
a network of computational nodes; and
a clock source that provides a clock signal to a subset of nodes of the network of computational nodes;
wherein the clock signal is distributed from each node of the subset of nodes to a respective adjacent node; and
wherein the clock signal is propagated via the adjacent nodes to any additional nodes of the network of computational nodes that are not among the subset of nodes or the adjacent nodes.

16. The system of claim 15, wherein:
the network of computational nodes comprises a plurality of rows and a plurality of columns arranged in a rectangular pattern;
the subset of nodes is arranged in one or more of the plurality of rows; and
the clock signal is distributed and propagated along each row via the plurality of columns.

17. The system of claim 16, wherein:
the subset of nodes includes two adjacent rows;
the clock signal is distributed and propagated upward along the plurality of columns from a first row of the two adjacent rows; and
the clock signal is also distributed and propagated downward along the plurality of columns from a second row of the two adjacent rows.

18. A system comprising:
a means for providing, from a clock source, a clock signal to a subset of nodes of a network of computational nodes;
a means for distributing, from each node of the subset of nodes, the clock signal to a respective adjacent node; and
a means for propagating, via the adjacent nodes, the clock signal to any additional nodes of the network of computational nodes that are not among the subset of nodes or the adjacent nodes.

19. The system of claim 18, wherein:
the network of computational nodes comprises a plurality of rows and a plurality of columns arranged in a rectangular pattern;
the subset of nodes is arranged in one or more of the plurality of rows; and
the distributing and propagating occur along each row via the plurality of columns.

20. The system of claim 19, wherein:
the subset of nodes includes two adjacent rows;
the distributing and propagating occur upward along the plurality of columns from a first row of the two adjacent rows; and
the distributing and propagating also occur downward along the plurality of columns from a second row of the two adjacent rows.
